(19) United States
(12) Patent Application Publication
(10) Pub. No.: US 2018/0225379 A1
(43) Pub. Date: Aug. 9, 2018

(54) Recommendation Based On Thematic Structure Of Content Items In Digital Magazine

(71) Applicant: Flipboard, Inc., Palo Alto, CA (US)

(72) Inventors: Arnab Bhadury, Vancouver (CA); Benjamin John Frederickson, Vancouver (CA); Diane Shir-Rae Chang, Sunnyside, NY (US); Tyler Monteferrante, San Francisco, CA (US)

(21) Appl. No.: 15/425,977

(22) Filed: Feb. 6, 2017

(51) Int. Cl. G06F 17/30; G06F 7/02

(52) U.S. Cl. CPC G06F 17/30867; G06F 7/026

(57) ABSTRACT

An online system automatically selects one or more content items in a digital magazine for recommendation based on a common theme of the content items and similarities of the content items. In one aspect, content items are associated with different latent topics. A latent topic identifies a theme or a concept of related content items, where the theme is determined based on a probability of words appearing together in one or more content items sharing the identified theme. From a set of content items on a common latent topic with a subject content item, one or more content items may be automatically identified based on content proximity scores of the set of content items with respect to the subject content item. One or more content items having a content proximity score within a predetermined range with the subject content item are selected for recommendation to a user.

### BACKGROUND

This disclosure relates generally to digital magazines, and more particularly to recommendation of content items based on the thematic structure of the content items in a digital magazine environment.

Digital distribution channels disseminate a wide variety of digital content including text, images, audio, links, videos, and interactive media (e.g., games, collaborative content) to users. Recent development of mobile computing devices such as personal computers, smart phones, tablets, etc., enables users to access numerous content items in various forms, and provide feedback for the content items.

Due to the proliferation of content items that could be presented in an electronic magazine, a user can be inundated with a vast amount of information from various sources. For example, a user may be shrouded by content items irrelevant to the user's interest. For another example, a user may encounter similar or duplicative content items. Thus, much of the information provided to existing digital magazines do not actually meet the user's interests or needs, and may overwhelm the user instead.

### SUMMARY

A computer-implemented method is disclosed for selecting one or more content items in a digital magazine for presentation to a user based on a common theme of the content items, and similarities of the content items. In one aspect, content items are associated with different latent topics. A latent topic is defined in a conceptual space over the vocabulary of words that are selected to represent the thematic structure of content items in the conceptual space. A latent topic identifies a theme or a concept of related content items, where the theme is determined based on a probability of words appearing together in one or more content items sharing the identified theme. From a set of content items on a common latent topic associated with a subject content item, one or more content items may be automatically identified based on content proximity scores of the set of content items with respect to the subject content item. The subject content item may be a content item selected to be presented or any content item previously presented to the user. Each content proximity score indicates a similarity of two or more content items. One or more content items having a content proximity score within a predetermined range with the subject content item are selected for recommendation to a user.

In one embodiment, a non-transitory computer-readable storage medium storing executable computer program instructions is disclosed. The non-transitory computer-readable storage medium stores executable computer program instructions for automatically associating content items with corresponding latent topics, and automatically identifying one or more content items from a set of content items assigned to a common latent topic with a subject content item based on content proximity scores of the set of content items with respect to the subject content item, as disclosed herein.

Advantageously, assigning content items to corresponding latent topics in a latent topic space allows a dimension of search of content items based on the latent topics to be smaller than a dimension of search of content items based on conventional topics comprising key words in a word space. For example, the dimension of a word space is determined by a number of words in the order of millions, while a dimension of a latent topic space is 1000 determined by a total number (e.g., 1000) of latent topics. Thus, a set of related content items using different vocabularies but sharing a common theme with a subject content item can be identified in an efficient manner. Moreover, selecting one or more content items from the set of related content items based on a content proximity score with respect to the subject content item enables duplicate content items with the subject content item to be excluded. Hence, non-duplicative content items sharing a common theme can be presented to a user.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### DESCRIPTION OF THE DRAWINGS

FIG. 1 is a block diagram of a system environment in which a content processing system operates, in accordance with an embodiment.

FIG. 2 is an example of a page template for presenting content using a digital magazine, in accordance with an embodiment.

FIG. 3 is an example block diagram of a content processing system in accordance with an embodiment.

FIG. 4 is an example block diagram of a client device in accordance with an embodiment.

FIG. 5 is an example block diagram of a latent topic association module in accordance with an embodiment.

FIG. 6 is an example block diagram of a content recommendation module in accordance with an embodiment.

FIG. 7 is an example flowchart of automatically generating latent topics and associating content items with corresponding latent topics in accordance with an embodiment.

FIG. 8 is an example flowchart of automatically selecting relevant content items of a latent topic in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

In one or more embodiments, content items are associated with different latent topics, and one or more content items from a set of content items associated with a common latent topic are identified based on content proximity scores measuring similarities of the set of content items. The selected one or more content items or an access (e.g., a thumbnail or hyperlink) to the selected one or more content items are presented to a user through a client device.

A latent topic identifies a theme or a concept related to multiple content items, where each content item includes words (or phrases) directly or indirectly related to the identified theme or concept. Words directly indicating relevancy of content items include key words or exact words shared among different content items. Words indirectly indicating relevancy of content items include semantically related words, non-semantically related words or a combination of them with a high probability to be presented in related content items sharing a common theme. For example, semantically related words such as “cat,” “kitten,” and “feline” have a high probability of being related to a cat topic, and semantically related words such as “dog,” “puppy,” “bark,” and “bone” have a high probability of being related to a dog topic. For another example, non-semantically related words such as “cat” and “dog” still have a high probability of being related to a pet topic. A word may occur in content items of different topics with a different probability in each topic. Hence, each content item can be characterized by a particular set of latent topics determined based on probability of words relating to the particular set of latent topics. By associating content items with corresponding latent topics, relevant content items sharing a common theme that may not share exact same words can be easily identified, and presented to the user.

Moreover, content proximity scores of content items are obtained to filter out content items that may be duplicative with each other. Such duplicative content items are identified from a set of content items associated with a common latent topic. Thus, content items that may use different vocabularies but likely will not provide any new information to a user can be excluded from being presented to the user.

### System Architecture

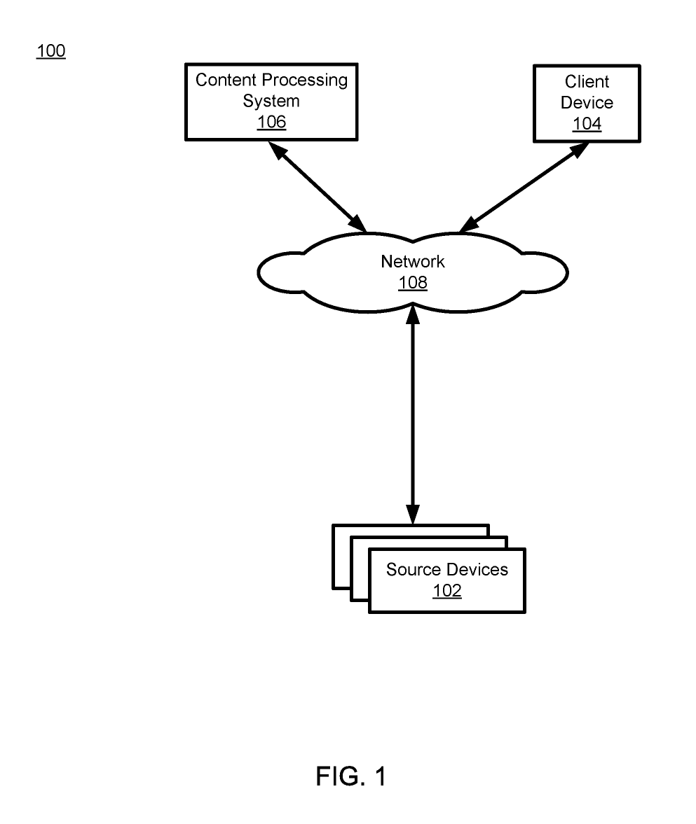

FIG. 1 is a block diagram of an embodiment of a system environment 100 for organizing and sharing content via a digital magazine. In the example shown by FIG. 1, the system environment includes one or more source devices 102, a client device 104, and a content processing system 106 connected to each other via a network 108. A source device 102 is a computing system capable of providing various types of content to a client device 104, the content processing system 106 or both. Examples of content provided by a source device 102 include text, images, video, or audio on web pages, web feeds, social networking information, messages, or other suitable data. Additional examples of content include user-generated content such as blogs, tweets, shared images, video or audio, social networking posts, social networking status updates, and advertisements. Content provided by a source device 102 may be received from a publisher (e.g., stories about news events, product information, entertainment, or educational material) and distributed by the source device 102. For convenience, content, regardless of its composition, may be referred to herein as an “article,” a “content item,” or as “content.” A content item may include various types of content, such as text, images, and video.

In one or more embodiments, the content processing system 106 is a digital magazine server that receives content items from one or more source devices 102, generates pages in a digital magazine by processing the received content, and serves the pages to a client device 104.

The client device 104 is a computing device capable of receiving user input as well as transmitting and/or receiving data via the network 108. In one embodiment, the client device 104 is a conventional computer system, such as a desktop or a laptop computer. Alternatively, the client device 104 may be a device having computer functionality, such as a personal digital assistant (PDA), a mobile telephone, a smartphone or another suitable device. In one embodiment, a client device 104 executes an application, such as a digital magazine application, that receives one or more pages generated by the content processing system 106 and presents the pages to a user of the client device 104. Additionally, an application executing on the client device 104 may communicate instructions or requests for content to the content processing system 106 to modify content presented to a user of the client device 104. As another example, the client device 104 executes a browser that receives pages from the content processing system 106 and presents the pages to a user of the client device 104. While FIG. 1 shows a single client device 104, in various embodiments, any number of client devices 104 may communicate with the content processing system 106.

Hence, the content processing system 106 obtains content items from multiple sources and generates one or more pages for presentation to the user that include the obtained content items in a suitable format. For example, the content processing system 106 determines a page layout including various content items based on information associated with a user and generates a page including the content items arranged according to the determined layout for presentation to the user via a client device 104. This allows the user to access content items via the client device 104 in a format that enhances the user's interaction and consumption of the content items. Accordingly, a user may achieve a reading experience of various content items from multiple source devices 102 via the client device 104 that replicates the experience of reading the content items via a print magazine. For example, a page generated by the content processing system 106 may present various content items in a layout that reduces horizontal or vertical scrolling by the user to access various content items presented on the page.

The source devices 102, client device 104, and the content processing system 106 are configured to communicate via the network 108, which may comprise any combination of local area and/or wide area networks, using both wired and/or wireless communication systems. In one embodiment, the network 108 uses standard communications technologies and/or protocols. For example, the network 108 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 108 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 108 may be represented using any suitable format, such as hypertext markup language (HTML) or extensible markup language (XML). In some embodiments, all or some of the communication links of the network 108 may be encrypted using any suitable technique or techniques.

### Page Templates

A page template is used by the content processing system 106 to describe a spatial arrangement (“layout”) of content items on a page for presentation by a client device 104. A page template includes slots, which each includes one or more content items. Each slot has a size (e.g., small, medium, or large) and an aspect ratio.

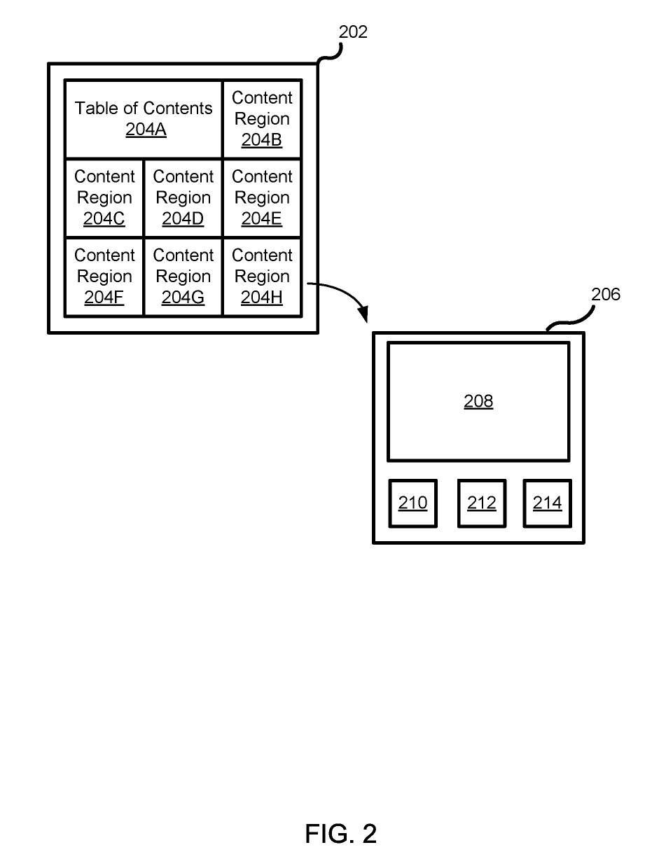

FIG. 2 illustrates an example page template 202 having multiple rectangular slots each configured to include a content item. Other page templates with different configurations of slots may be used by the content processing system 106 to present one or more content items received from source devices 102. In some implementations, a page template may reserve one or more slots for specific types of content items having specific characteristics. For example, one or more slots in a page template are reserved for content items that are images. As another example, a page template may include a slot reserved for presentation of social network status updates, and the status updates may be grouped and displayed as a list in the slot included in the page template. In another example, one or more slots in a page template may be associated with content items received from a specific source device 102 or provided by a specific publisher (e.g., a specified news organization, a specified magazine, content generated by a specified user, etc.).

As shown in FIG. 2, when a content processing system 106 generates a page, the content processing system 106 populates slots in a page template 202 with content items. Information identifying the page template 202 and the associations between content items and slots in the page template 202 is stored and used to generate the page. For example, the identified page template 202 and content items are retrieved, and the page is generated by including content items in slots of the page template 202 based on the associations. As used herein, a slot in which a content item is presented may be referred to as a “content region.”

A content region 204 may include image data, text, data, a combination of image and text data, or any other information retrieved from a corresponding content item. For example, content region 204A represents a table of contents identifying sections of a digital magazine that are represented by content regions 204B-204H. For example, content region 204A includes text or other data identifying a table of contents, such as “Cover Stories featuring,” followed by one or more identifiers associated with various sections of the digital magazine. An identifier associated with a section may describe a characteristic common to at least a threshold number of content items in the section. For example, an identifier refers to the name of a user of social network from which content items included in the section is received, such as a user to which a user associated with the client device 104 has formed a connection, association, or relationship via a social networking system. As another example, an identifier associated with a section specifies a topic, a newspaper, a magazine, a blog author, or other publisher associated with at least a threshold number of content items in the section. Additionally, an identifier associated with a section may further specify content items selected by a user of the content processing system 106 and organized as a section. Content items included in a section may be related topically and include text and/or images related to the topic.

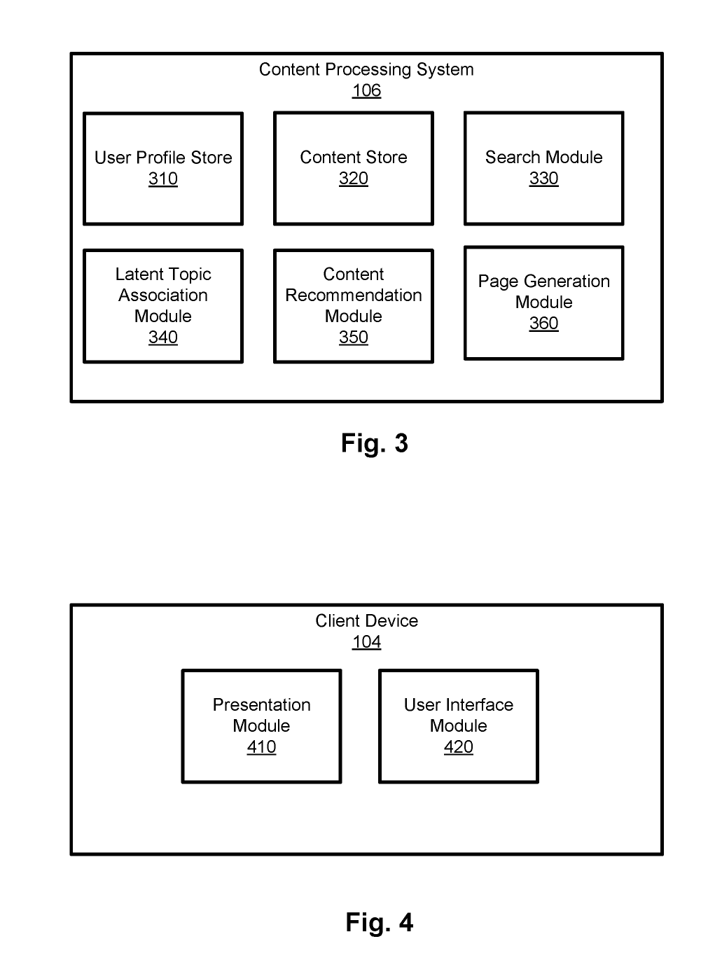

Sections may be further organized into subsections, with each subsection also represented by a content region describing one or more content items included in the subsection. Referring to FIG. 2, content region 204H may include a newspaper including three subsections represented by subsections 208, 210, 212, 214. Accessing a content region 204H presents an additional page 206 generated from a page template used by the newspaper. In one example, the additional page 206 includes a subsection 208 corresponding to the selected content region 204H for presenting a content item (e.g., a new article, a video clip, etc.) and additional subsections 210, 212, 214 for recommending content items related to the content item in the content region 204H. The subsections 210, 212, 214 may include thumbnails or hyperlinks for providing access to recommended content items. Content items for recommendation are selected as further described below in detail with respect to FIGS. 3 through 8. Further, a subsection may include one or more subsections, allowing the digital magazine to provide content items in a hierarchical structure.

FIG. 3 is a block diagram of an example diagram of a content processing system 106. In one embodiment, the content processing system 106 includes a user profile store 310, a content store 320, a search module 330, a latent topic association module 340, a content recommendation module 350, and a page generation module 360. These components operate together to identify content items for recommendation to a user based on latent topics, generate content pages including identified content items, and transmit the content pages to the client device 104 for presentation. In other embodiments, the content processing system 106 may include different, fewer, or additional components.

The user profile store 310 stores user profiles. A user profile includes information about the user that was explicitly shared by the user and may also include profile information inferred by the content processing system 106. In one embodiment, a user profile includes multiple data fields, each describing one or more attributes of the corresponding user. Examples of information stored in a user profile include biographic, demographic, and other types of descriptive information, such as gender, hobbies or preferences, location, a list of previous content items consumed by a corresponding user, data describing interactions by the user in response to content items presented by the content processing system 106, or other suitable information.

The content store 320 stores various types of digital content from the source devices 102. Examples of content items stored by the content store 320 include a page post, a status update, a photograph, a video, a link, an article, video data, and any other type of digital content.

The search module 330 receives a search query from a user through the client device 104 and retrieves content items from one or more source devices 102 or from the content store 320 based on the search query. For example, content items having at least a portion of an attribute matching at least a portion of a search query are retrieved from one or more source devices 102. In one embodiment, the search module 330 generates a section of the digital magazine including the content items identified based on the search query.

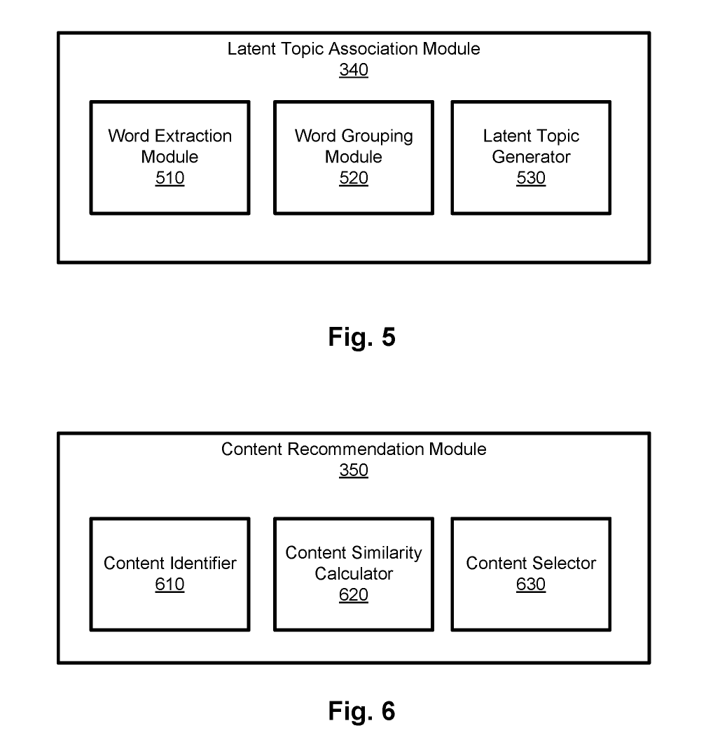

The latent topic association module 340 automatically associates content items with corresponding latent topics. The latent topic association module 340 retrieves a plurality of content items, for example periodically, and extracts words included in the content items. The latent topic association module 340 may obtain a set of words (e.g., key words or all words) from the extracted words. The latent topic association module 340 performs latent semantic language analysis (e.g., latent semantic analysis in natural language processing) on the set of words to group semantically related words. Additionally, the latent topic association module 340 determines a probability of two or more of the set of words appearing together in a same content item or content items sharing a common theme, and groups the two or more words having the probability above a predetermined threshold. The latent topic association module 340 associates each group of words to a corresponding latent topic, and assigns a latent topic to a content item including any word from a group of words associated with the latent topic, where each word has a probability of being related to the latent topic. A single content item may be assigned to multiple latent topics. Latent topic of a content item can be identified by identification (e.g., a title or a unique document number) of the content item, for example, through a lookup table. Accordingly, a dimension of search of the content items based on latent topic (e.g., 1000) is less than a dimension of search of the content items based on simple key words (e.g., over a million). As a result, relevant content items sharing relevant context but not the exact words can be identified in an efficient manner. The latent topic association module 340 is further described with reference to FIG. 5.

The content recommendation module 350 receives an identification of a subject content item, and determines other content items for recommendation to the user. The subject content item may be a content item requested by a client device 104, or any one of previous content items consumed by a user operating the client device 104. In one aspect, the content recommendation module 350 identifies a latent topic assigned to the selected content item. Among content items sharing the latent topic, the content recommendation module 350 determines content proximity scores of the content items. Each content proximity score (e.g., cosine distance) represents a similarity of a content item with respect to the selected content item. For example, a cosine distance between ‘0’ and ‘0.1’ indicates a high similarity between two content items, where a cosine distance between ‘0.4’ and ‘1.0’ indicates a low similarity between two content items. In addition, the content recommendation module 350 filters a subset of the content items that are too similar or almost identical and another subset of the content items that are too distinct (e.g., cosine distance between ‘0.4’ and ‘1.0’) with respect to the subject content item. The content recommendation module 350 selects a remaining subset of the content items having a content proximity score within a predetermined range (e.g., cosine distance between ‘0.1’ and ‘0.4’) for recommendation to the user. The content recommendation module 350 is further described with reference to FIG. 6.

The page generation module 360 generates page information (e.g., page template) describing a layout of different content items to be presented. In one aspect, the page generation module 360 generates page information describing a page that includes a selected content item to be presented and the content items for recommendations determined by the content recommendation module 350. The selected content item may be a content item requested by the client device 104 or any previous content items presented to the user. The page generation module 360 retrieves content items from one or more source devices 102 or from the content store 320, and generates a page including the content items. The page generation module 360 may associate the content item with a section configured to present a specific type of content item or to present content items having one or more specified characteristics. The page information is transmitted to the client device 104 for presentation.

FIG. 4 is a block diagram of a client device 104 according to one embodiment. In the embodiment illustrated in FIG. 4, the client device 104 includes a presentation module 410, and a user interface module 420. These components operate together to present content items in digital magazine pages to a user of the client device 104. In other embodiments, the client device 104 may include different, fewer, or additional components.

The presentation module 410 receives the page information describing a page including content items from the content processing system 106 (e.g., page generation module 360), and renders a visual representation of the page, for example, as shown in FIG. 2.

The user interface module 420 receives the user input, and executes the user input. In one example, the presentation module 410 displays the page on a touch display device, and the user interface module 420 detects a user operation (e.g., touch, drag, flip, pinch, etc.) corresponding to a desired user input. For example, the user interface module 420 detects a touch on a region by a user, and determines a user input as a selection of a content item associated with the region. The user interface module 420 then forwards the user input of requesting the selected content item to the content processing system 106, by which a page including the selected content item and other recommended content items or thumbnails for accessing the selected content items can be generated for presentation to the user.

FIG. 5 is an example diagram of the latent topic association module 340. In one embodiment, the latent topic association module 340 includes a word extraction module 510, a word grouping module 520, and a latent topic generator 530. These components operate together to automatically determine latent topics among content items, and associate content items with corresponding latent topics. In other embodiments, the latent topic generator 530 may include different, fewer, or additional components.

The word extraction module 510 retrieves multiple content items from one or more source devices 102, and extracts unique words included in the content items. The word extraction module 510 may retrieve content items periodically, or when requested. The word extraction module 510 may continuously monitor a particular source device 102, and retrieves any updated content item from the particular source device 102. The word extraction module 510 may obtain a set of words (e.g., key words) or all unique words in the content items. The number of the extracted unique words from a content item represents the dimension of the content item in word space.

The word grouping module 520 groups one or more words from the words obtained by the word extraction module 510. The word grouping module 520 groups words that may not be literally exact but semantically related. Moreover, the word grouping module 520 groups words that may not be semantically related but likely to appear together in one or more content items associated with a particular theme. A set of words grouped together may be assigned to a corresponding latent topic.

In one aspect, the word grouping module 520 performs semantic language analysis on the vocabulary of words to group semantically related words into a latent topic. For example, words “cat,” “kitten,” and “feline” may be identified as semantically related words of a latent topic of cat. In one approach, the word grouping module 520 generates semantic proximity scores, each indicating a degree of semantic relationship between two corresponding words, and groups different words having a semantic proximity score above a predetermined semantic proximity threshold value.

In addition, the word grouping module 520 determines a probability of two or more of the plurality of words appearing together in one or more content items associated with a particular theme, and further groups the two or more words likely to appear together. A probability of different words forming a topic depends on 1) word co-occurrences in documents, and 2) topic co-occurrences of the word. First, the word grouping module 520 separates the vocabulary into topics that are as separable as possible (i.e., topic co-occurrences are less frequent). In other words, most words are prominent only in a small number of topics (like, ‘cat’ in topics related to pets, animals, cats, home etc.) Hence, the word grouping module 520 obtains word co-occurrences of a plurality of words in the documents, and determines that words like ‘cat’, ‘dog’, ‘kitten’ often appear together, and forms a topic including the determined words. Next, the word grouping module 520 reassigns topics such that the topics look as unique as possible in terms of probability of words associated with each topic. Then, with the reassigned topics, the words grouping module 520 reevaluates topic co-occurrences. The word grouping module 520 iterates the process until the latent topics stop changing.

For example, the word grouping module 520 analyzes different content items and determines that despite words “cat” and “dog” are not semantically related, the word grouping module 520 determines that there is a high probability of the words “cat” and “dog” appearing together in one or more content items related to a common theme (e.g., “pet”) above a predetermined probability threshold value. Hence, the word grouping module 520 groups the words “cat,” “dog” and their semantically related words e.g., “feline,” “kitten,” “canine,” and “puppy,” together. In some aspect, the probability of words appearing together in one or more content items sharing a common theme is time dependent. For example, words “Donald Trump” and “Presidential Election” may not be semantically related, and may not likely appear together in content items published before year 2016, but may have a high probability of appearing together in content items published in year 2016. Hence, the word “Donald Trump” and “Presidential Election” may be grouped together for content items published in year 2016, but not for content items published before year 2016.

Accordingly, a latent topic represents a thematic structure of content items having one or more words grouped into the latent topic, where the probability of each word of appearing in the topic can be different. For example, given a word “cat,” it is not deterministic to classify it to a certain topic, but the probabilities of the word “cat” appearing on latent topics of cat and pet may provide clear indication where the word “cat” is commonly appearing in a latent topic space.

The latent topic generator 530 maps each content item to one or more latent topics. For example, the latent topic generator 530 associates a latent topic to a group of words determined by the word grouping module 520. The latent topic may be the most frequently used word (e.g., “cat”) from a group of words (e.g., “cat,” “feline,” “kitten,” “dog,” “canine,” and “puppy”), a representative word (e.g., “pet”) not included in the group of words, or a unique identification such as a character, a number, a symbol, or any combination of them. In addition, the latent topic association module assigns a latent topic to a content item including any word from the group of words associated with the latent topic. Hence, a single content item may be mapped to multiple latent topics. Accordingly, a content item can be identified by a set of associated latent topics, and a vector of probabilities of the latent topics being related to the content item. For example, for five latent topics topic1, topic2, topic3, topic4, topic5, a first content item can be identified by a vector of [0, 0.1, 0.5, 0.3, 0.1], where each number in the vector represents a probability of a respective latent topic being related to the first content item. In this example, topic 1 represented with ‘0’ has no relevance with the first content item, and topic 3 presented with ‘0.5’ has a 50% relevance with the first content item. The latent topic generator 530 stores identifications of content items and assigned latent topics in a lookup table.

By grouping words that likely appear together in one or more content items associated with a corresponding theme/latent topic, a number of latent topics (e.g., 1000) can be less than a number of conventional topics defined in word space (e.g., over millions) determined based on exact key words. Accordingly, an identification of related content items can be performed in a reduced search space.

FIG. 6 is an example diagram of the content recommendation module 350. In one embodiment, the content recommendation module 350 includes a content identifier 610, a content similarity calculator 620, and a content selector 630. These components operate together to automatically select one or more content items from a set of content items associated with a latent topic based on a similarity of content items with respect to a subject content item. The selected content items may be added to a page for recommendation to the subject content item. In other embodiments, the content recommendation module 350 may include different, fewer, or additional components.

The content identifier 610 receives an identification of a subject content item, and determines one or more latent topics associated with the subject content item. The subject content item may be a content item to be presented at the client device 104, or any previous content items consumed by a user operating the client device 104. The content identifier 610 identifies one or more latent topics assigned to the subject content item, for example through a lookup table from the latent topic generator 530.

The content similarity calculator 620 determines similarities of content items with respect to a subject content item. In one aspect, the content similarity calculator 620 obtains content proximity scores of the content items with respect to the subject content item, where a content proximity score represents a similarity of two content items. Example measures of similarity include cosine similarity/distance or the generalized Euclidean distance between a vector representing the subject content item and a vector representing the content item being evaluated. In one embodiment, a content proximity score for a content item is determined based on a characteristic vector for a cluster including the content item. The characteristic vector for a cluster is based at least in part on vectors describing one or more content items in the cluster. For example, the characteristic vector for a cluster is a mean of the vectors in the cluster. The content proximity score of the content item may be determined based on a measure of similarity between the vector corresponding to the subject content item and a characteristic vector of the cluster including the candidate content item. An example content proximity score includes a cosine distance. For example, a cosine distance of two content items between ‘0’ and ‘0.2’ indicates that the two content items are more similar to each other than two content items having a cosine distance between ‘0.4’ and ‘1.’

The content selector 630 selects a subset of the content items from a set of content items associated with a latent topic. In one aspect, the content selector 630 compares content items based on the content proximity scores of the content items, and selects the subset of content items having content proximity scores within a predetermined range (e.g., a cosine distance between ‘0.2’ and ‘0.4’). A list of the selected subset of the content items can be provided to the page generation module 360 for generating a page. Accordingly, content items that are too similar or almost identical (e.g., a cosine distance between ‘0’ and ‘0.2’), and content items that are too distinct (e.g., a cosine distance between ‘0.4’ and ‘1’) can be excluded. Because the selection is performed from the set of content items associated with the latent topic, content items using different vocabularies yet likely conveying duplicate information with the subject content item can be filtered out in an efficient manner.

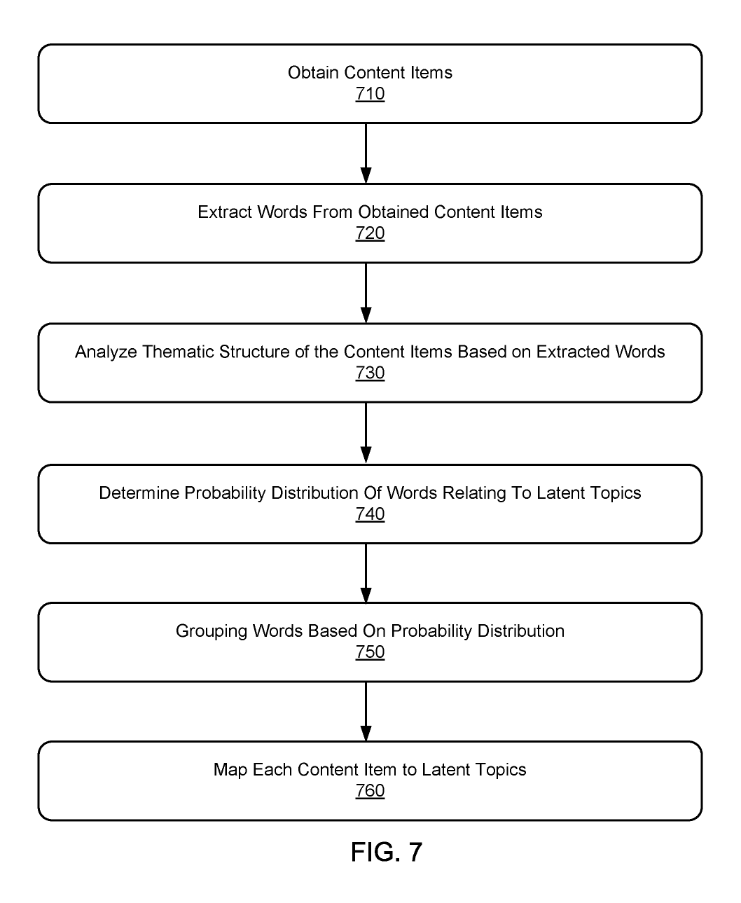

FIG. 7 is an example flowchart of generating latent topics, and associating content items to corresponding latent topics. The steps in FIG. 7 may be performed by the latent topic association module 340. In other embodiments, some or all of the steps may be performed by other entities. In addition, some embodiments may perform the steps in parallel, perform the steps in different orders, or perform different steps.

The content processing system 106 obtains 710 content items from source devices 102, and extracts 720 words from the content items. In addition, the content processing system 106 analyzes 730 the thematic structure of the content items based on the extracted words, e.g., by applying a semantic language analysis to group semantically related words among the extracted words. Moreover, the content processing system 106 determines 740 a probability distribution of words relating to latent topics, and groups 750 words based on the probability distribution. In particular, words having a probability of appearing in one or more content items related to a latent topic over a predetermined threshold are associated with the latent topic.

The content processing system 106 maps 760 each content item to one or more latent topics. The content processing system 106 may assign a latent topic to a content item including one or more of the group of words associated with the latent topic. As set forth above, a content item may be assigned to multiple latent topics.

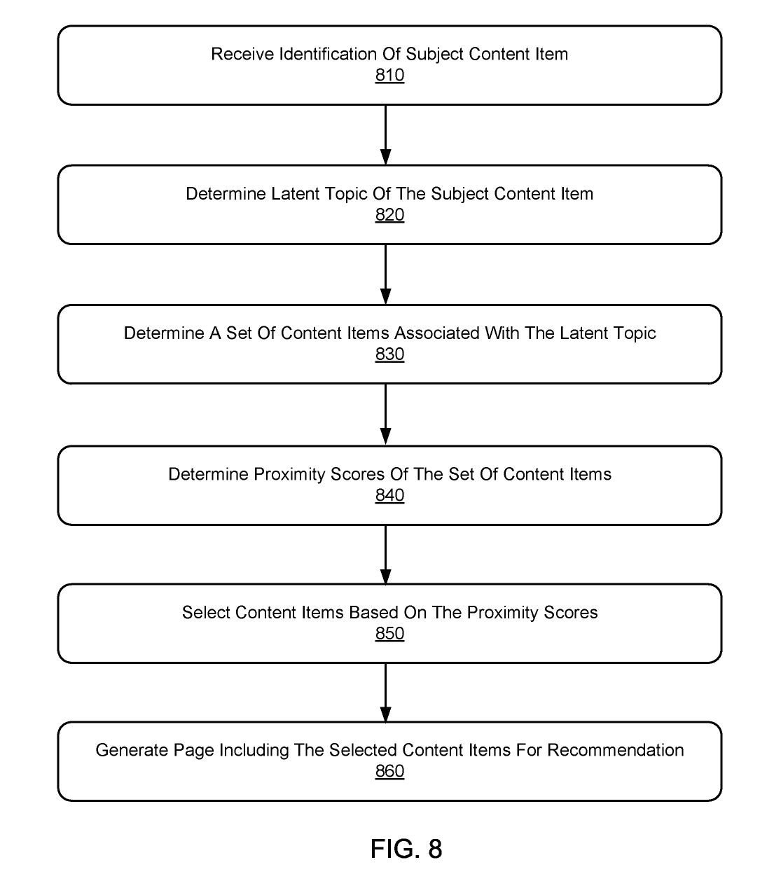

FIG. 8 is an example flowchart of selecting content items relevant to a subject content item, according to a latent topic. The steps in FIG. 8 may be performed by the content recommendation module 350. In other embodiments, some or all of the steps may be performed by other entities. In addition, some embodiments may perform the steps in parallel, perform the steps in different orders, or perform different steps.

The content processing system 106 receives 810 an identification of a subject content item. The subject content item may be a content item to be displayed for presentation at the client device 104. The subject content item may have been selected by a user through the client device 104, or automatically selected by the content processing system 106, for example, based on a popularity of the content item, user preference, and/or previous history of content items consumed by the user.

The content processing system 106 determines 820 a latent topic of the subject content item. The latent topic assigned to the subject content item may be identified by searching for a latent topic associated with an identification of the subject content item in a lookup table indicating associations between content items and latent topics. In addition, the content processing system 106 determines 830 a set of content items associated with the latent topic from the lookup table.

The content processing system 106 determines 840 content proximity scores of the set of content items with respect to a subject content item. The subject content item may be a content item requested to be displayed by the client device 104.

The content processing system 106 selects 850 content items from the set of content items associated with a latent topic based on the content proximity scores of the content items with respect to the subject content item. The content processing system 106 may select a content item having a content proximity score within a predetermined range to exclude content items that are too similar with the subject content item and content items that are too distinct from the subject content item from the set of content items. Hence, content items including duplicative information with the subject content item may be omitted.

The content processing system 106 may additionally generate 860 a page including a subject content item and selected content items having content proximity scores within a predetermined range for recommendation. The content processing system 106 generates page information describing a layout of the subject content item and the selected content items, and transmits the page information to the client device 104 for presentation.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer readable medium (e.g., non-transitory computer readable medium) containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

What is claimed is:

1. A computer-implemented method performed by a computer system for selecting one or more content items for recommendation in a digital magazine, the method comprising:
associating each content item of a plurality of content items with corresponding latent topics, each latent topic identifying a corresponding theme of associated content items determined based on a probability of words appearing together in the associated content items sharing the corresponding theme;
selecting a set of content items for a subject content item based on latent topics associated with the set of content items and a latent topic associated with the subject content item;
calculating a content proximity score for each content item of the set of content items with respect to the subject content item, each content proximity score associated with a content item representing a similarity between the content item and the subject content item; and
selecting the one or more content items from the set of content items based on the content proximity scores associated with the set of content items.

2. The method of claim 1, further comprising:
generating page information describing a page including the subject content item and the selected one or more content items; and
transmitting the page information to a client device for presentation of the page.

3. The method of claim 1, wherein each of the content proximity score is a cosine distance between a corresponding one of the set of content items with respect to the subject content item.

4. The method of claim 1, wherein a proximity score associated with a content item below a first threshold value is determined to be a duplicate of the subject content item.

5. The method of claim 1, wherein a proximity score associated with a content item exceeding a second threshold value is determined to be thematically distinct from the subject content item in a conceptual space.

6. The method of claim 1, further comprising:
excluding content items being duplicates of the subject content item and content items being thematically distinct from the subject content item from being selected for presentation together with the subject content item.

7. The method of claim 1, wherein associating each content item of the plurality of content items with corresponding latent topics comprises:
extracting a plurality of unique words from a content item;
analyzing the plurality of words to identify at least one thematic structure of the content item, the thematic structure representing a latent topic of the content item in a conceptual space; and
generating a set of latent topics based on the analysis of the plurality of words of the content item.

8. The method of claim 7, wherein analyzing the plurality of words comprises grouping two or more words having at least a threshold probability of the two or more words appearing together in one or more content items related to the latent topic.

9. The method of claim 8, further comprising:
identifying a content item including one or more of the grouping of the two or more words related to a latent topic; and
mapping the identified content item to the latent topic.

10. The method of claim 1, wherein a latent topic is defined in a conceptual space by a vocabulary of words, and wherein each word in the vocabulary has a probability of being associated with the latent topic.

11. A non-transitory computer readable medium storing executable computer program instructions for selecting one or more content items for recommendation in a digital magazine, the computer program instructions when executed by a computer processor cause the computer processor to:
associate each content item of a plurality of content items with corresponding latent topics, each latent topic identifying a corresponding theme of associated content items determined based on a probability of words appearing together in the associated content items sharing the corresponding theme;
select a set of content items for a subject content item based on latent topics associated with the set of content items and a latent topic associated with the subject content item;
calculate a content proximity score for each content item of the set of content items with respect to the subject content item, each content proximity score associated with a content item representing a similarity between the content item and the subject content item; and
select the one or more content items from the set of content items based on the content proximity scores associated with the set of content items.

12. The non-transitory computer readable medium of claim 11, wherein the computer program instructions when executed by the computer processor further cause the computer processor to:
generate page information describing a page including the subject content item and the selected one or more content items; and
transmit the page information to a client device for presentation of the page.

13. The non-transitory computer readable medium of claim 11, wherein each of the content proximity score is a cosine distance between a corresponding one of the set of content items with respect to the subject content item.

14. The non-transitory computer readable medium of claim 11, wherein a proximity score associated with a content item below a first threshold value is determined to be a duplicate of the subject content item.

15. The non-transitory computer readable medium of claim 11, wherein a proximity score associated with a content item exceeding a second threshold value is determined to be thematically distinct from the subject content item in a conceptual space.

16. The non-transitory computer readable medium of claim 11, wherein the computer program instructions when executed by the computer processor further cause the computer processor to:
exclude content items being duplicates of the subject content item and content items being thematically distinct from the subject content item from being selected for presentation together with the subject content item.

17. The non-transitory computer readable medium of claim 11, wherein the computer program instructions when executed by the computer processor that cause the computer processor to associate each content item of the plurality of content items with corresponding latent topics further cause the computer processor to:
extract a plurality of unique words from a content item;
analyze the plurality of words to identify at least one thematic structure of the content item, the thematic structure representing a latent topic of the content item in a conceptual space; and
generate a set of latent topics based on the analysis of the plurality of words of the content item.

18. The non-transitory computer readable medium of claim 17, wherein the computer program instructions when executed by the computer processor that cause the computer processor to analyze the plurality of words further cause the computer processor to group two or more words having at least a threshold probability of the two or more words appearing together in one or more content items related to the latent topic.

19. The non-transitory computer readable medium of claim 18, wherein the computer program instructions when executed by the computer processor further cause the computer processor to:
identify a content item including one or more of the grouping of the two or more words related to a latent topic; and
map the identified content item to the latent topic.

20. The non-transitory computer readable medium of claim 11, wherein a latent topic is defined in a conceptual space by a vocabulary of words, and wherein each word in the vocabulary has a probability of being associated with the latent topic.
